(19) United States
(12) Patent Application Publication
(10) Pub. No.: US 2002/0094869 A1
(43) Pub. Date: Jul. 18, 2002

(54) Methods and systems of providing real time on-line casino games

(76) Inventor: Gabi Harkham, Los Angeles (CA)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/867,146

(22) Filed: May 29, 2001

(30) Foreign Application Priority Data
May 29, 2000 (AU) PQ7841/00

(51) Int. Cl. A63F 13/00

(52) U.S. Cl. 463/42

(57) ABSTRACT

Methods and systems of providing real time on-line casino games are disclosed. A remote player connects to an on-line server that hosts a game center. A flexible security program allows a web site to select one or more user information fields as required verification fields for entering the web site. A card scanner at a game table scans a card and reads a code embedded in the card that indicates the type of the card. Cameras at the game table capture the video images of the game table. The video images and the type of the card are transmitted by the server to the remote player. Playing instructions from the remote player are transmitted to the game table and displayed by a remote instruction system at the game table. Slot machine statistics such as amount and frequency of recent winnings are provided to help players select a favorite slot machine to play. Other games such as trivia games, computer games and wagering on sporting events can be provided to enable remote players to play against the game center or other remote or physical players. Player reward programs are displayed and offered to the players.

This application claims priority under 35 U.S.C. 119(a) from Australian Provisional Application No. PQ7841/00 titled “METHOD OF AND SYSTEM FOR PROVIDING AN ON-LINE CASINO GAME” and filed on May 29, 2000. The above-referenced Australian Provisional Application is incorporated by reference in its entirety by the present application.

### BACKGROUND OF THE INVENTION

1. Field of the Invention

This invention relates to methods and systems of providing real time on-line casino games.

2. Description of the Related Art

On-line casinos have been established to allow remote players to enter a web site and play simulated casino games. Since the casino games are simulated by computer, the remote players do not have the realistic experience of playing at a real casino with real dealers and interacting with other players. The remote players cannot rely on a real dealer to deal real cards, but must rely on a computer algorithm to generate virtual cards. Players cannot be assured that the virtual cards are generated fairly.

To provide a more realistic experience to remote players, and to alleviate their concern of a computer generating virtual cards to disfavor the players, video images at a game table of a real casino can be transmitted to remote players. Because remote players can see the video images of the game being played, they will find the experience more realistic. However, video images captured by typical cameras may not be able to reliably and automatically capture images of the cards being dealt. In addition, transmitting video images may not be suitable for a remote player with limited bandwidth connection. Although a human operator can determine and enter information such as the types of cards dealt or the types of dices rolled to be transmitted to a remote player, such a process may be time consuming and vulnerable to human error. Therefore, it is desirable to read cards reliably and to automatically determine the type of every card being dealt, and to transmit such information in a space-saving non-video format to remote players.

Almost all casinos have slot machines. Many players believe that selecting the “right” slot machine can improve one's chance of winning. Many players believe that the ideal slot machine is one that has been played a lot recently but has not awarded large winnings. Since a large amount has been entered into the slot machine but the slot machine has not returned a large winning, it is believed that this slot machine is primed to return a large winning. Other players believe that a slot machine that has frequently awarded winnings in a recent period is an ideal machine. Therefore, many players spend time to observe slot machines before they select one to play. However, making such observations requires time and patience. For remote players, it is difficult, if not impossible, to observe slot machines at a casino. Therefore it is desirable to provide player with statistics on slot machines, such as the amount of money entered into the slot machine within certain time intervals, the amount of winning returned by the slot machines within certain time intervals, the amount and the time of the last large winning, and so forth. Statistics on real slot machines as well as computer simulated slot machines can both be stored and made available.

Credit cards are often used to make on-line purchases. Using credit cards carries security risks, because once a victim's name, card number and expiration date are obtained, a third person can use the victim's credit card account to make purchases. A smart card provides security against credit card fraud. Commercial embodiments of smart cards include the Blue Card from American Express. To use a smart card to make a purchase at a web site, a user typically inserts the smart card into a smart card drive connected to the user's personal computer. For example, a Blue Card user can insert the card into a compatible card drive that connects to an USB port of the user's personal computer. A user can also swipe the smart card at a smart card reader connected to a game center. The smart card reader can be located at an ATM machine, a remote gaming kiosk at a shopping mall, a game table local console at the game center, and so forth. After inserting or swiping the smart card, the user is usually prompted to enter a pin number for identification. A chip in the smart card stores information about the user. The web site retrieves user information stored on the smart card. The web site may optionally retrieve additional information about the user at a database, for example a database maintained by a credit card company. Since the user needs both the smart card and a pin number to use the smart card, smart cards are safer than credit cards. To alleviate the cost of buying and installing smart card drives, smart disks allow smart card information to be stored on the smart disks and to be read by floppy disk drives.

Although smart cards and smart disks are safer than credit cards, they do not provide flexibility and security at the same time. For applications that only require a low level of information, requiring users to enter pin numbers may be too inconvenient to the users. For applications that require a high level of information, requiring users to enter pin numbers may not provide enough security, since pin numbers are typically only four digits in length and can be cracked through trial and error, especially if an automated process is used to try different pin number combinations. If users are required to enter a pin number of greater length, the users will be further inconvenienced when they use the smart card/smart disk to access applications that do not require strict security. What is desired is a flexible solution that provides sufficient security for different types of applications without adding inconvenience to the users.

### SUMMARY OF THE INVENTION

One aspect of the invention relates to a game table for a remote player to participate in a card game, the game table including a card scanner configured to scan a card and to determine a type of the card, the card having an embedded code that indicates the type of the card, the card scanner being connected to a server, the server being configured to transmit the type of the scanned card to the remote player, one or more cameras connected to the server, the cameras being configured to capture video images of the game table, the server being further configured to transmit the captured video images to the remote player, and a remote instruction system configured to receive playing instructions from the remote player through the server, and to display the received playing instructions at the game table in visual or audio form.

Another aspect of the invention relates to a method of enabling a remote player to select a slot machine to play, the method including storing statistics of a first slot machine and statistics of a second slot machine, displaying to the player at least a summary of the stored statistics of the first slot machine, displaying to the player at least a summary of the stored statistics of the second slot machine, and prompting the player to select a slot machine from a plurality of slot machines, the plurality of slot machines including the first slot machine and the second slot machine.

Another aspect of the invention relates to a method of creating security requirements at a web site, the method including displaying a plurality of available verification fields to an administrator of the web site, prompting the administrator to select one or more verification fields from the plurality of available verification fields, and prompting a user to enter data into the selected verification fields when the user requests entry into the web site.

Another aspect of the invention relates to a method of enabling a remote player to participate in a game at a physical game center, the method including prompting the remote player to connect to a server that hosts the physical game center, verifying that the remote player is permitted by his/her jurisdiction to play at the game center,, verifying that the remote player is financially qualified to play at the game center, identifying a financial account of the remote player, prompting the remote player to enter playing instructions, receiving the entered playing instructions at the game center, playing a game at the game center according to the received playing instructions, transmitting a status of the played game to the remote player, optionally transmitting video images of the played game to the remote player, and updating a balance of the identified financial account of the remote player.

Another aspect of the invention relates to a method of a player playing a game at a remote physical game center, the method including connecting to a server that hosts the game center, entering verification information to satisfy legal requirements, entering playing instructions to a game to be played or being played at the game center, receiving a status of the played game from the server, and optionally receiving video images of the played game from the server.

Another aspect of the invention relates to a method for enabling a remote player to participate in a game played in a casino remotely located from said remote player and providing the remote player with a realistic game experience that substantially captures the visual and audio feel and excitement of the casino. The method includes transmitting images to the remote player of a game in progress, transmitting to the remote player sounds of the game and voices of a dealer and on-site players, identifying a financial account of the remote player, prompting the remote player when it is the remote player's turn to play to enter playing instructions during the game, receiving at the casino the entered playing instructions from the remote player while the game is being played, receiving from the remote player an amount of wager specified by the remote player, communicating to the remote player the ongoing status of the game in substantially real time, and communicating to the remote player an amount of balance retained by the remote player.

### BRIEF DESCRIPTION OF THE DRAWINGS

FIG. 1 is a diagram showing one embodiment of users connecting to game centers.

FIG. 2 is a diagram showing one embodiment of users connecting to a hotel game center.

FIG. 3 is a flowchart showing one embodiment of the verification process.

FIG. 4 is a diagram showing one embodiment of a game table.

FIG. 5 is a diagram showing one embodiment of a system for delivering data to remote players.

FIG. 6 is a flowchart showing one embodiment of a process of allowing a user to play a slot machine.

FIG. 7, comprising FIG. 7A and FIG. 7B, is a flowchart showing one embodiment of a remote player playing process.

FIG. 8 is a flowchart showing one embodiment of a process of a remote player playing a game of chess against another player.

FIG. 9 is a diagram showing one embodiment of a client device display.

### DETAILED DESCRIPTION OF THE PREFERRED EMBODIMENT

### Overview

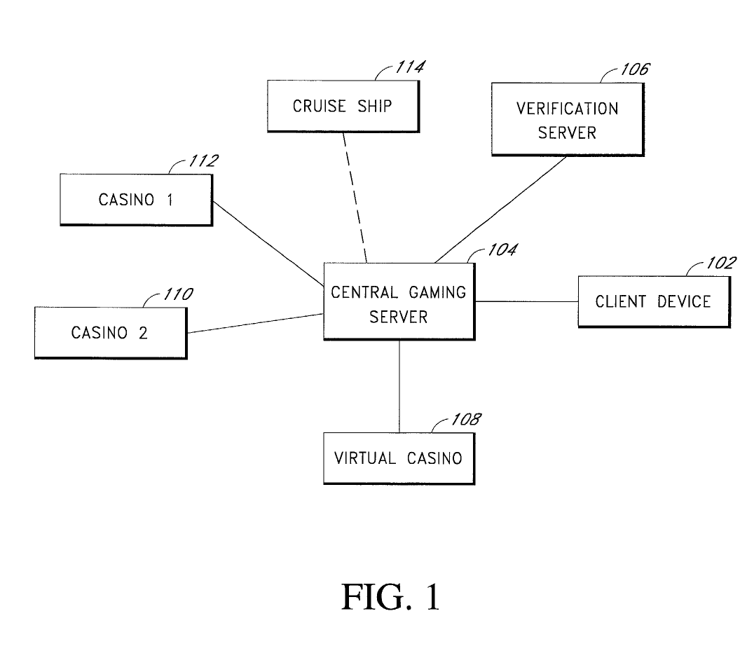

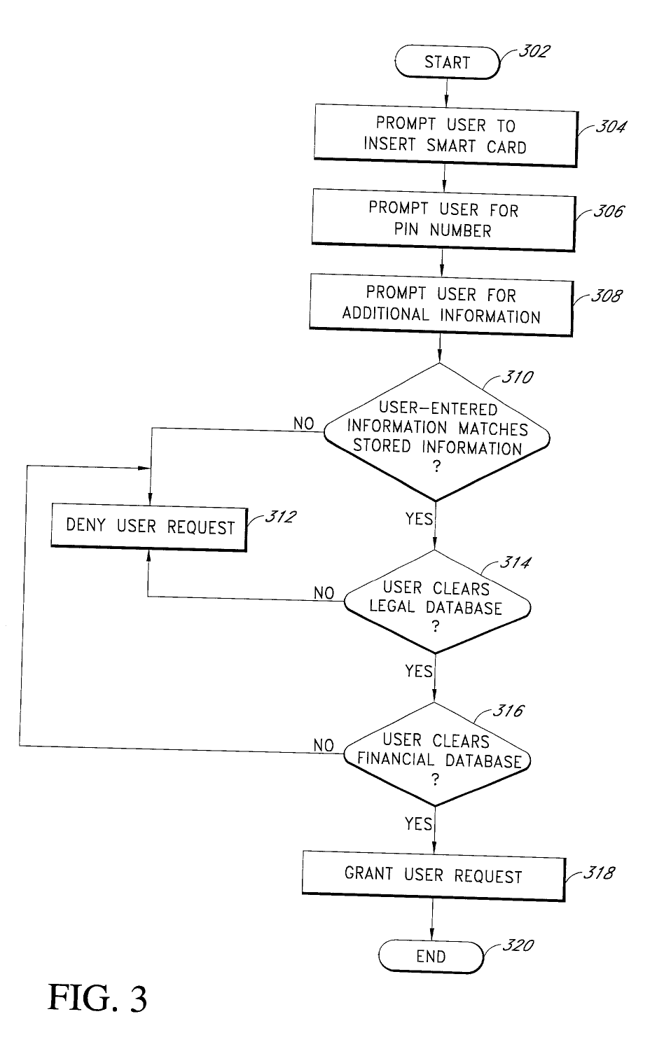

FIG. 1 is a diagram showing one embodiment of users connecting to game centers. Users use client devices 102 to connect by wire or wirelessly to an on-line central gaming server 104 through a network. The client devices 102 may include personal computers, network appliances, mobile phones, televisions, video game consoles, custom gaming devices, a gaming console on a passenger airline or a cruise ship, and so forth. Video game consoles include devices such as Sony Playstation, Nintendo Gameboy, Microsoft X Box, and so forth. Custom gaming devices include devices custom designed for playing one or more casino games. For example, one custom gaming device may include buttons of “hit”, “stay”, “double”, “split”, and “buy insurance”, etc., corresponding to instructions in playing a Black Jack game. Another custom gaming device may include selection buttons for the user to select playing instructions displayed on a screen of the device. The network can be the Internet or an Intranet. The game server 104 verifies that the user is legally allowed and financially able to play. In one embodiment, the verification is performed by a verification server 106. The verification server 106 can be connected to a financial institution such as a bank or a credit bureau. In another embodiment, the verification is performed by the central gaming server 104. More details of the verification process are described below in connection with FIG. 3.

The central gaming server 104 is connected to game centers, including a virtual casino 108, a first casino 110, a second casino 112, and a cruise ship gaming facility 114. In one embodiment, a virtual casino 108 is a casino with real dealers and real game tables but only accepts remote players. In another embodiment, a virtual casino 108 is a computer-simulated casino, it has no real dealers or real game tables. Each game center may be hosted by secondary servers that are connected to the central gaming server 104. The dealers receive playing instructions from remote players and play the games at the game tables according to the instructions. The first casino 110 and the second casino 112 are casinos with physically present players but also equipped to allow playing by remote users. A casino can also include a chain of casino establishments linked by a network. A cruise ship gaming facility 114 can be connected wirelessly to the central gaming server 104.

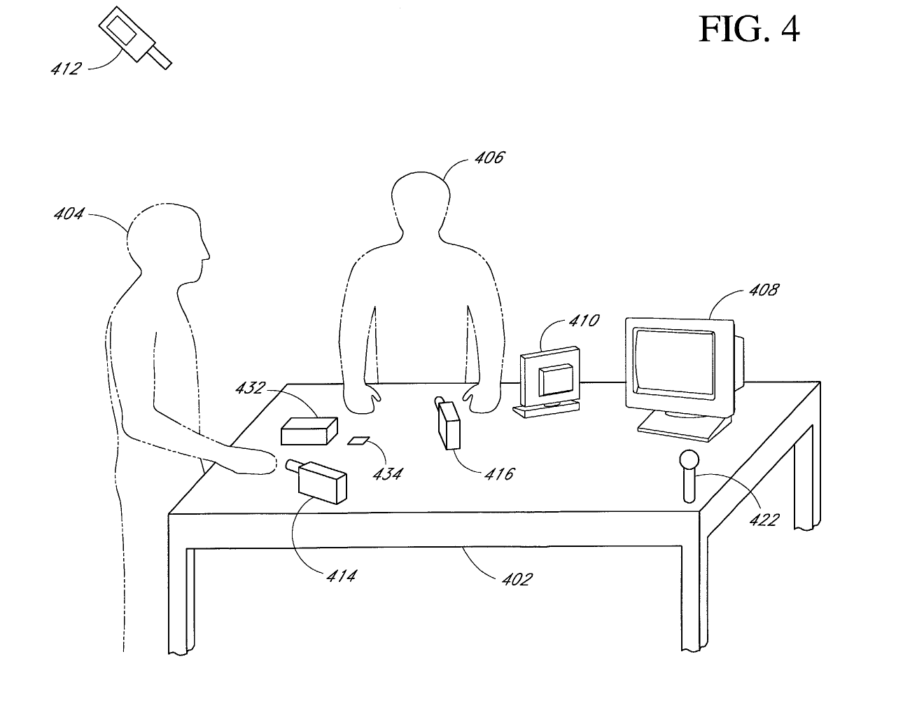

Through the central gaming server 104, a user selects a game center 108, 110, 112, or 114 to play. In another embodiment, the user directly connects to a game center server without accessing the central gaming server 104. The user identifies from the client device 102 a game to be played at the game center. The identified game that includes the user is then started at the game center. The game of blackjack is described in the specification as an example. Throughout the game, game information such as the cards dealt to the user, to the dealer, and to other players at the table, and/or video images of the table, the dealer, the other players and the surrounding environment are transmitted by the central gaming server 104 or a game center server from the game center to the user's client device 102. User instructions such as hit, hold, split, double, or purchase insurance are transmitted through the central gaming server 104 or a game center server to the game center. User instructions may also include instruction to tip the dealer. A dealer at the game center then follows the user's instructions in playing the game. More details of transmitting game information are described below in connection with FIG. 4.

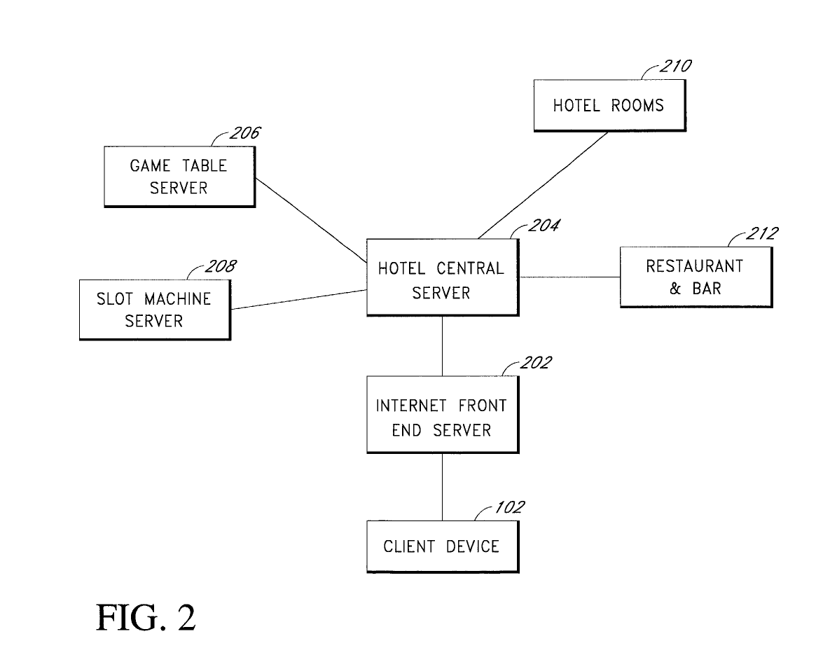

FIG. 2 is a diagram showing one embodiment of users connecting to a hotel game center. A user connects from the client device 102 to an Internet front end server 202. In one embodiment, the Internet front end server 202 is maintained or monitored by a government agency to ensure fairness. The Internet front end server 202 verifies the user and connects the user to the hotel central server 204, which is connected to a game table server 206 and a slot machine server 208. In another embodiment, the Internet front end server 202 uses an additional verification server connected to a third party such as a financial institution to verify the user. The user can then choose to play a table game such as Black Jack, Caribbean Studs, Roulette, and so forth, or play a slot machine. The game table server 206 facilitates the remote playing of the table games. The slot machine server 208 facilitates the remote playing of the slot machine games. In another embodiment, the user can also choose to play other types of games, for example trivia games such as Jeopardy, Who Wants to be a Millionaire, and so forth, board games such as Chess and Monopoly, computer games and wagering on future outcomes such as sporting events. The hotel central server 204 also connects to hotel rooms 210 and restaurants and bars 212. Hotel patrons can access the hotel central server 204 to play table games or slot machines from their hotel rooms, using devices connected to the hotel central server 204, such as televisions with remote controls, video game appliances, or custom gaming devices. Patrons at restaurants and bars 212 can also access the hotel central server 204 to play table games or slot machines, using devices connected to the hotel central server 204, such as televisions, video game appliances, or custom gaming devices.

### Verification

FIG. 3 is a flowchart showing one embodiment of the verification process. A start block 302 proceeds to block 304. At block 304, a server prompts a user to insert the user's smart card into a smart card drive connected to the client device 102. In another embodiment, instead of inserting the card into a smart card drive, the user inserts a smart disk that stores the user's smart card information into a floppy disk drive. In yet another embodiment, the user swipes the smart card on a smart card reader connected to the game center. Block 304 proceeds to block 306. At block 306, the server prompts the user to enter a pin number associated with the smart card. Block 306 proceeds to block 308. At block 308, the server prompts the user to enter additional verification information, such as the user's address, social security number, or other personal information. In one embodiment with a low level of information requirement, the server does not prompt the user for additional verification information. Block 308 proceeds to block 310. At block 310, the server compares the user-entered information including the pin number and the additional verification information against the data stored on the smart card. In another embodiment, the server compares the user-entered information against user data stored at a database, such as the database of a credit card company or a casino. If the user-entered information does not match the data stored on the smart card or data stored at the database, then block 310 proceeds to block 312. In one embodiment of block 312, the server prompts the user to enter verification information again. In another embodiment of block 312, the server denies the user request for game play. The server may take additional steps such as notifying organizations such as the user's credit card company, the company that issued the smart card, and/or the game center.

Still referring to FIG. 3, if the user-entered information matches the user data stored on the smart card or the database, then block 310 proceeds to block 314. At block 314, the server examines the user demographics information stored in the smart card or stored at the database, such as the age of the user and the jurisdiction of the user against a legal database stored at the server or connected to the server. The legal database stores information on whether a jurisdiction permits its residents or citizens to participate in on-line gaming, and the age over which its residents or citizens are permitted to participate in on-line gaming. The legal database can store additional information about each jurisdiction, such as the jurisdiction's regulations on different types of on-line gaming. For example, a jurisdiction may have different rules regarding on-line gaming for non-profit purposes as compared to on-line gaming for profit. For another example, a jurisdiction may permit its residents or citizens to only play in game centers organized or monitored by its government. For yet another example, a jurisdiction may limit its residents or citizens to playing with a certain credit limit or playing certain types of games. The information obtained from the legal database can be used by the server to make jurisdiction-specific accommodations, for example, to only offer certain games permitted by the jurisdiction to its residents or citizens, and to limit the type and amount of credit that can be used by its residents or citizens in gaming. If the examination determines that the user is not permitted by its jurisdiction to join the game center, then block 314 proceeds to block 312, where the server informs the user and denies the user request to join.

Still referring to FIG. 3, if the user demographics information clears the legal database, then block 314 proceeds to block 316. At block 316, the server examines the user against information stored on the smart card, information stored at a financial database of the game center, or information stored at a financial database of a third party financial organization such as a bank or a credit card company. In one embodiment, the server examines the user information against a financial database of people who are financial risks. In another embodiment, the server checks the user's financial information stored on the smart card and/or stored at the financial database, such as the user's available credit, to ensure that the user has sufficient funds to join game play. In one embodiment, the user is prompted to designate an account, such as a smart card account, a digital cash (or e-wallet) account, a credit card account, or a debit card account as the account from which wager amounts will be drawn and winnings will be transferred to.

In one embodiment in which the server checks user information against a financial database, the server preferably terminates connection with the financial database after it obtains required information from the financial database. In one embodiment, the server re-establishes connection with the financial database after the user has finished playing and is ready to exit the game center, and updates the user's account balance or other user information at the financial database. If the user is deemed not financially qualified to play, then block 316 proceeds to block 312 to deny the user request to join. Otherwise block 316 proceeds to block 318, where the server grants the user's request to join the game center. The server can also make adjustments based on the information of the user. For example, having known the country of the user, the server can recommend games that are popular within that country to the user, or display a user interface in the language of the country. Block 318 proceeds to an end block 320.

The user is optionally prompted to designate a playing limit, so that when the user's playing loss or playing loss plus the current wager has reached the playing limit, the user is reminded of the playing limit and asked to exit the game center. In one implementation, the user is allowed to increase the playing limit when the limit has been reached. In one embodiment, the user is optionally prompted to designate a playing limit in terms of playing frequency or playing time. For example, the user can limit his/her playing limit to a maximum of five hours within a seven-day period, or no more than once within a day. When the user's playing time or playing frequency exceeds the limit, the user is asked to exit the game center. In one implementation, the user is allowed to increase the playing limit when the limit has been reached. The playing limit option can be used to prevent excessive gaming and/or excessive gaming loss. The playing limit can be stored on a database connected to the server or a smart card or smart disk of the player. In one embodiment, the playing limit is enforced by all the game centers hosted by the server, so that the player cannot move to another game center to circumvent the playing limit.

### Smart Card Program Providing Multiple Levels of Security

A smart card program can be installed by web sites that use smart cards or smart disks to verify users. The smart card program specifies multiple levels of security. In one embodiment, three levels of information requirements are specified. The first level requires reading the smart card by a smart card drive or smart card reader, or reading the smart disk by a floppy disk drive. It does not require the user to enter a pin number. The second level requires reading the smart card/smart disk and the entering of a pin number. The third level requires reading the smart card/smart disk, the entering of a pin number, and the entering of additional verification information, for example the user's social security number, address, full name, and/or date of birth. Information such as the user's pin number, address, full name, date of birth, and purchase history can be stored on the smart card or at a user database of a credit card company or game center. In one embodiment, a web site verifies user-entered information against information stored on the smart card. In another embodiment, a web site uses the user identification information entered by the user or stored on the smart card to find a user's records at the user database. The web site then verifies user-entered information against the user's information stored at the user database.

After the smart card program is installed on a web site, the level of information required for the web site or for each sub-site of the web site is determined. For example, for reading a member-only newspaper article, the first level of information may be applied to allow ease of access by members. For logging into a personal email account, the second level of information may be applied to provide the right balance of security and ease of access. For buying an expensive item on-line, the third level of information may be applied to ensure security. A web site can be categorized into multiple sub-sites, for example a member-only sub-site and a public area sub-site. Each sub-site includes one or more web pages of the web site.

In one embodiment, a web site administrator installs the smart card program and selects from a list of verification fields the fields to be used for each level of information. For example, the user's date of birth can be selected as the required entry field for the second level of information, and the user's zip code and pin number can be selected as the required entry fields for the third level of information. In theory, every field of information that is stored on the smart card/smart disk can be used as a verification field. If the web site connects to a database for verification, every field of user information stored on the database can also be used as a verification field. Using the smart card program, the web site administrator can specify a security level for each sub-site or each web page of the web site.

### Game Table Devices

FIG. 4 is a diagram showing one embodiment of a game table. In the example illustrated by FIG. 4, a Black Jack game is played by a dealer 404, a physical player 406, and a remote player at the game table 402. The remote player is represented by the remote instruction system 408. In one embodiment, the remote instruction system 408 includes a screen, which displays the remote user's playing instructions. In another embodiment, the remote instruction system 408 includes multiple display buttons titled “hit”, “stay”, “double”, “split”, “buy insurance”, and so forth. Corresponding display buttons are activated according to the remote user's playing instructions.

In one embodiment, the player instruction system 408 also displays video images of the remote player. Video images of the remote player are captured by a camera connected to the remote player's client device 102. Displaying video images of the remote player provides the dealer 404 and the physical player 406 with more comfort toward the remote player. It also deters fraudulent and underage players. In another embodiment, a remote player transmits a photo file from the client device 102 to the player instruction system 408 as his/her identification. A remote player can also select an image representation as an avatar of himself/herself.

In one embodiment, the player instruction system 408 includes a speaker, which plays audio signals of playing instructions from the remote player. In one implementation, the playing instructions are transmitted from the client device 102 to the game center in non-audio format as text or numerical information. Transmitting playing instructions in non-audio format reduces the bandwidth and storage space requirements. The playing instructions are then converted into audio format to be played by the play instruction system 408. Since the number of playing instructions for a game is limited, a limited number of corresponding audio files can be played to represent the playing instructions. In another implementation, the player instruction system 408 receives playing instructions in audio format but in a foreign language spoken by the remote player. The player instruction system 408 then automatically translates the playing instructions into the default language used by the game center. Since the vocabulary associated with game play instructions is very limited, a translation module with limited memory and high processing speed can be provided to provide fast and accurate translation. The translation can also be performed by a server, which then transmits the translated audio to the player instructions system 408.

The dealer 404 deals cards out of a card shoe 432. Each card is embedded with a code, which is scanned by a card scanner 434. The card scanner 434 can be placed inside the card shoe 432, on the game table 402, or above the game table 402. The card scanner 434 determines the type of the card. The card information is then transmitted to the remote user. More details of card scanning are described below in the section titled “card scanning methods and devices.”

A number of cameras can be used to capture video images to be transmitted to the remote player. For example, an overhead camera 412, a dealer camera 414 facing the dealer 404, and a physical player camera 416 facing the physical player 406, can be used to capture video images. A plurality of cameras can be placed such that each camera aims at a seat of the game table 402. The cameras can be turned on when the dealer or a physical player occupies the seat. A microphone 422 can be used to record audio signals at the game table 402 to be transmitted to the remote user. The microphone 422 can be used to record the voices of the dealer 404 and physical players 406, and sounds of the game such as the sound of cards being dealt or a wheel being spun. In one embodiment, video phones are used to transmit images and audio signals between the remote player 408 and the game table 402. The video phone at the game table 402 can be aimed to capture images of the cards dealt to the remote player 408. More details of providing video images are described below in the section titled “providing video images to the player.”

In one embodiment, each physical player 406 uses a local console 410 at the game table to play the game. In one embodiment, the local console 410 and the remote instructions system 408 are interchangeable, because each includes the features of the other. Therefore each device occupies a fixed location at the game table 402, and functions as a local console 410 or a remote instructions system 408 depending on whether a physical player or a remote player is using the device. The local console 410 allows the physical player 406 to enter play instructions such as “hit”, “stand”, and so forth. The physical player 406 enters play instructions, for example by pressing buttons on the local console 410, clicking a mouse of the local console 410, or by speaking voice commands to the local console 410. The local console 410 can be integrated into the game table 402. For example, the buttons, display screen, or microphone of the local console 410 can be placed on the game table 402. In one embodiment, the entered instructions are transmitted to the server, which transmits the information to the remote player. Therefore the remote player can be informed of the plays of physical players at the game table 402.

Requiring physical players 406 to enter instructions into local consoles 410 has another advantage. Since hand signals representing instructions such as “hit” and “stand” are subject to interpretation, physical players in occasion have challenged dealer's interpretation of their hand signals as incorrect. Requiring physical players 406 to use local consoles 410 reduces the need for dealer interpretation and the possibility of player challenge. In one embodiment, the local console 410 is also configured to allow the physical player 406 to participate in conversation with remote players at the game table 402, for example by using a chat room or an instant messaging service. Each game table 402 can be organized as a chat room. Game tables 402 that play the same type of game can also be organized as a chat room. To provide better visual representation, a three-dimensional chat room can be used by remote and physical players. Players can be represented by three-dimensional avatars that can change motions or expressions. The local console 410 can also be equipped with a credit card reader or a smart card reader to accept the physical player 406's credit card or smart card, so that the physical player 406 can use his/her credit card or smart card account to play the game.

In another embodiment, the plays of physical players 406 are captured by cameras 412 and 416 and/or the microphone 422. The video and/or audio data is then transmitted from the server to the client devices 102 of the remote players, to inform the remote players of the plays of the physical players 406.

### Card Scanning Methods and Devices

Cards are often dealt quickly by a dealer 404 from a card shoe 432 to the game table 402, making capturing video images of the cards difficult. In addition, a remote user may contest that because the video image is unclear, he/she had mistaken the displayed video image of one card as another card. For remote players with limited bandwidth connection, transmitting video images of cards may result in delay. It is therefore advantageous to scan cards to quickly and reliably determine the type of card dealt without controversy, and to transmit such information to remote players in a space-saving non-video format.

In one embodiment, each card is embedded with a code that indicates the type of the card, such as Spade of Seven, Ace of Heart, and so forth. The code is preferably unreadable by humans. In one embodiment, a code is printed on the face up side of a card, so that a human can only see the code when he/she holds the card face up.

In one embodiment, the humanly unreadable code is embedded in a low-cost miniature chip. Commercial embodiments of a miniature chip cost as low as several cents. The code embedded in the chip is read by a chip reader, for example a chip reader that reads the code by transmitting a radio signal to the chip and receiving a returned radio signal that identifies the embedded code. In another embodiment, the code can also be embedded in a bar code, and a bar code scanner scans the bar code as the card is removed from the card shoe 432. In yet another embodiment, the code is embedded as an invisible bar code in the card, and an infrared scanner scans the code as the card is removed from the card shoe 432. Making the bar code invisible not only further prevents player fraud, but also improves aesthetics of the cards. The scanning device connects to the server. The server transmits the card-type information to the client device 102. The client device 102 receives the card-type information and advantageously uses a display application such as a Java applet to display the card in a graphic form to the user.

Referring to FIG. 4, in operation at a game table 402, a server determines the number of physical and remote players that participate in the game. The number of physical players 406 can be determined and entered into the server by the dealer 404 of the game table 402. The number of physical players 406 can also be determined by using video images of the cameras at the game table 402, or by counting the number of active local consoles 410 at the game table 402. As a card is removed from the card shoe 432 and scanned by a card scanner 434, the destination of the card (i.e., dealt to the dealer 404, dealt to a remote player, or dealt to a physical player 406) is immediately determined, because the number of players have been determined and the order of dealing cards (clock wise or counter clockwise at the game table 402) is fixed. The server then displays to the remote players the cards dealt to each party at the game table 402. In embodiments in which a player typically only read his/her own cards, for example in Caribbean Studs, single-deck Black Jack, Pai-gow, and Let It Ride, the server then only displays to a remote player the cards dealt to him/her. After a game ends, the type of cards dealt to other players can be transmitted to the remote player to ensure him/her that the game has been played fairly. In one embodiment, the dealer flips every dealt card on the game table 402 to be face up, the video images of the flipped cards and/or the scanned card type information of the flipped cards are transmitted to remote players.

In some games at least a dice is rolled. For example, in the game of Craps, two dices are rolled. In one embodiment, a human operator records the resulting number(s) of the dice(s) on a recording device connected to the server. For example, the human operator enters a number from one through six for each rolled dice on the recording device, or selects a button from the buttons “one” through “six” of the recording device for each rolled dice. In another embodiment, an overhead camera captures an image of the rolled dice(s). For each rolled dice, a pattern recognition program analyzes the image of the rolled dice to determine the resulting number of the dice. Since only up to six possible outcomes are associated with each dice, and since each of the six possible outcome images are relatively simple, a pattern recognition program can be programmed to quickly and reliably determine the result of the rolled dices.

In another embodiment, information such as cards dealt and dices rolled are captured as video images by cameras at the game table 402 and sent to the remote player. However, doing so requires relatively high clarity video images. Therefore large bandwidth is required for connecting the player to the network, and the player may experience a delay time in seeing the images. In yet another embodiment, the scanned card/dice information and the video images of cards/dices are both displayed to the remote player. Therefore the player can use the scanned information for clear viewing and quick playing. The video images provide realistic feelings to the player of being physically present at the game table.

### Providing Video Images to the Player

Video cameras are placed at the game center to capture video images to be streamed to the client device 102. Audio data can also be recorded by microphones and streamed to client devices 102. The microphones can be placed at game tables 402 or on dealers 404.

In one embodiment, when a remote player starts playing at a particular game table 402, the video images captured by the overhead camera 412 at the game table 402 is streamed to the player's client device 102. Since most game centers already have overhead cameras installed for monitoring purposes, the existing overhead cameras simply need to be connected to a server to stream video images to remote player.

In another embodiment, a plurality of cameras are placed at each game table 402. For example, one camera 412 is directed at the game table 402, another camera 414 is directed at the dealer 404, other cameras 416 are each directed at a physical player 406 at the game table 402. The video images captured by the plurality of cameras are streamed to the user's client device 102. The video images captured by the plurality of cameras can be displayed at one combined picture, or as multiple pictures each within an individual window. The remote user 408 at the client device 102 is therefore able to have a realistic experience, because the user is able to watch the images of the dealer 404 and the physical players 406 at the game table 402. A camera can also be used to capture images of multiple physical players 406 at the game table 402. For example, a camera can be programmed to aim at a physical player 406 or the dealer 404, and then switch aim to a different physical player 406 after every three seconds. A motion sensitive camera or a voice sensitive camera can also be used to aim at the physical player 406 or the dealer 404 that spoke or moved.

As described above in connection with FIG. 4, remote players can capture video images of themselves by using cameras connected to their client devices 102. The video images are then transmitted to the server. When multiple remote players 408 are playing at the same game table 402, video images of the remote players 408 can be used to enhance interaction between the remote players 408. In one embodiment, video images of the remote player 408 is displayed at its remote instruction system 408, and captured by a camera that is aimed at the remote instruction system 408. The video images captured by the camera can then be transmitted to other remote players 408. In another embodiment, the server receives the original video images of remote players 408 and transfers them directly to the client devices 102 of the other remote players 408 at the same game table 402. Additional interaction features, such as chat rooms or instant message services, can also be provided. Instead of video images, a remote player 408 can also use a photo to represent his/her presence at the game table 402.

In addition to video images and photos, a holographic image can be displayed at a game table 402 to represent the presence of a remote player 408. A holographic image is a three-dimensional image formed by the interference between a coherent laser beam and the light scattered by the object being imaged. The image can be viewed when illuminated by the same light that formed the image. In one embodiment, holographic images of the dealer 404, the cards being dealt, the physical players 406 and/or the game table 402 are recorded at the game center and transmitted to the remote player's client device 102. The client device 102 then reproduces the holographic images. In another embodiment, a remote player 408 is prompted at his/her client device 102 to select a default holographic image from a list of default holographic images. The list of default holographic images represents different types of persons, for example persons of different gender, age, and ethnicity combinations. The default image selected by the player is then displayed at the game table 402 to represent the remote player 408. By using default holographic images, the remote player 408 does not need to record a holographic image of himself or herself. The remote player 408 also does not need to transmit his/her image data from the client device 102 to the server. Only the remote player's selection of an image needs to be transmitted. According to the received user selection, the selected default holographic image is then displayed at the game table 402. In yet another embodiment, a holographic system at the remote player's location records a holographic image of at least a portion of the remote player 408, for example the remote player's head. A holographic image can be recorded by illuminating the target with laser. The image record is then transmitted to the server and used to reproduce a three-dimensional holographic image of the remote player 408 at the game table 402.

Streaming video images requires substantial bandwidth. In one embodiment, a server adjusts delivery rate depending on the bandwidth of the client device 102. For example, if a client device 102 is connected to the server by a T-1 line, the server then streams video images to the client device 102 at a high rate, such as equal to the camera refresh rate of the cameras at the game table 402. If a client device 102 is connected by a 28.8 Kb modem, then the server streams video images to the client device 102 at a lower rate. In another embodiment, the remote player is allowed to adjust video image delivery rate. A higher delivery rate provides a more realistic experience, but a lower delivery rate typically still provide sufficient information for game play. In one embodiment in which video images from a plurality of cameras can be streamed to the user, the remote player is allowed to select video images from only some of the plurality of cameras to be streamed or displayed. For example, instead of video images of the dealer 404 and other physical players 406, the remote player 408 may choose to have only video images of the game table 402 streamed or displayed. The remote player 408 may choose to have video images transmitted only after a card is dealt.

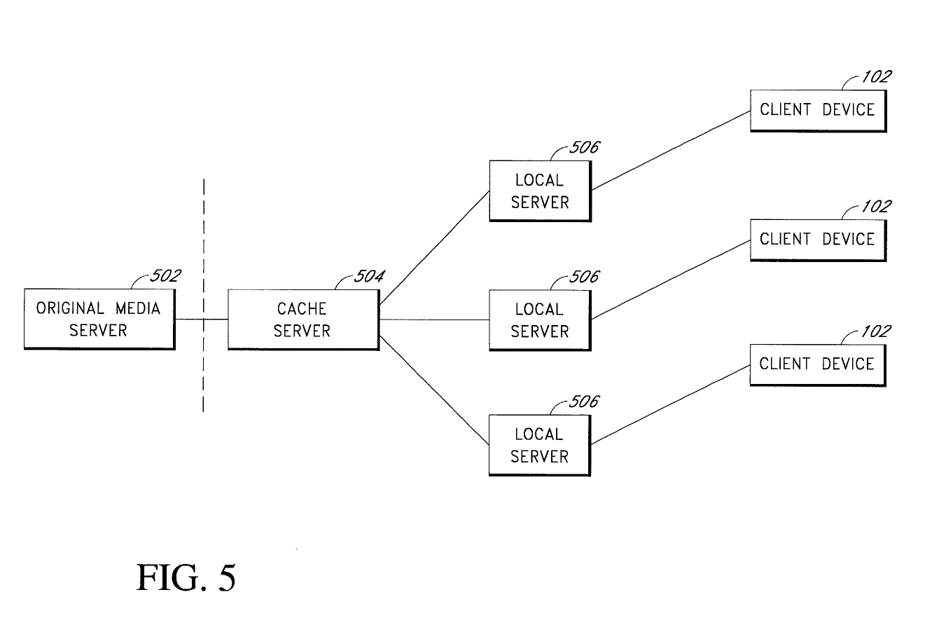

FIG. 5 is a diagram showing one embodiment of a system for delivering data to remote players 408. The original media server 502 is connected to a cache server 504, which is connected to multiple local servers 506. Each local server 506 stores at least a portion of the original media server 502's data. When a client device 102 requests data, the cache server 504 selects a particular local server 506 to deliver data to the client device 102. In one embodiment, the local server 506 with the shortest physical distance to the client device 102 is selected. In another embodiment, the local server 506 with the shortest network distance to the client device 102 is selected. In yet another embodiment, the local server 506 with the least network congestion to the client device 102 is selected. Commercial embodiments of cached delivery and delivering data to the “edge” of the network have been provided by companies such as Netcache, Inktomi, Akamai, and so forth.

Commercial software-on-demand applications such as Extent's EXEtender allow software to be transmitted to the client device 102 without installation. For example, in one embodiment in which the client device 102 is a personal computer, software for providing a remote player-game center game interface is transmitted from a server to the memory of the personal computer for execution, without the need for installing the software on the hard drive of the personal computer. Therefore software can be executed almost instantaneously, without the time consuming installation process and the need for storing the software on the hard drive. The likelihood of unauthorized copying is also reduced. Software can be streamed to the client device, so that at any particular moment only a necessary portion of the software is streamed to the client device 102. Therefore client devices 102 with limited storage space can execute large software programs.

### Providing Slot Machine Statistics to the Player

The statistics associated with a real or virtual slot machine can be displayed to the player. The statistics can include the last time the slot machine awarded a winning to a player, the last time the slot machine awarded a large winning (such as above $100) to a player, the amount of winnings, the total amount of winnings awarded by the slot machine in certain time intervals, the total amount of money entered into the slot machine in certain time intervals, the result of the last 100 plays, and so forth. Although the statistics are advantageously stored and displayed to players automatically, statistics can also be entered by operators who observe playing slot machines. Although human data entry may be labor intensive, it can be limited to, for example, recording statistics only for high roller slot machines that require large amounts to play, or only recording certain statistics such as the occurrence of large winnings. The slot machines of the game center can be linked together, or linked to slot machines of other game centers, to increase the potential jackpot amount. The slot machine statistics provide the players with information and incentive to play. The player is enabled to select a slot machine to play after reviewing the statistics. The statistics data can also be used to comply with government regulations, to monitor the fairness of the slot machine operation, and to provide tax, auditing and reporting information to the game center or investors.

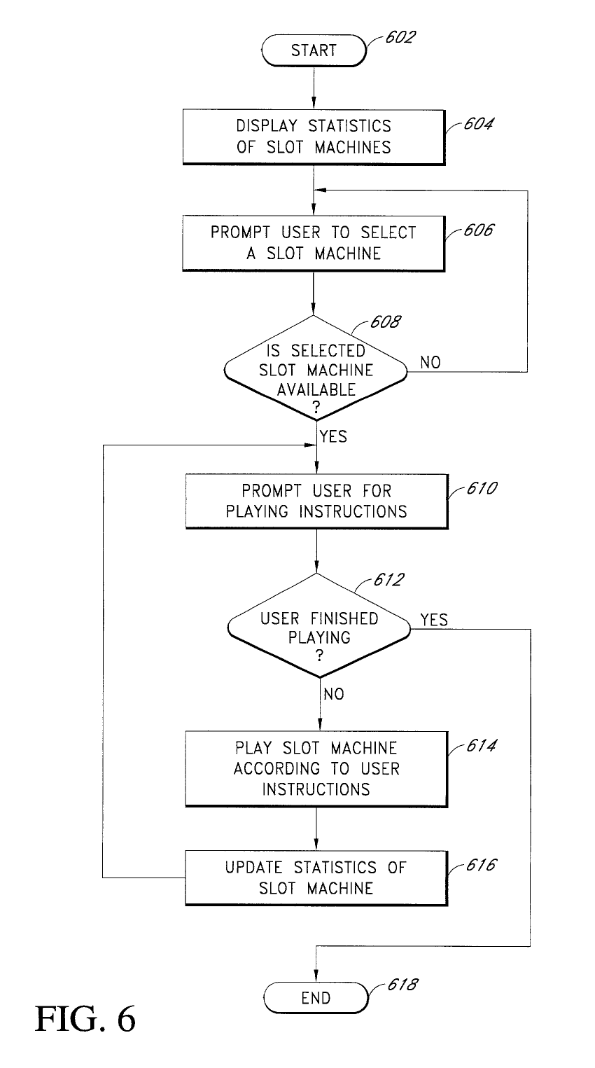

FIG. 6 is a flowchart showing one embodiment of a process of allowing a player to play a slot machine. A start block 602 proceeds to block 604. At block 604, the server displays statistics associated with each slot machine to the player. In one embodiment, the slot machines are virtual slot machines, i.e., computer simulated slot machines. The statistics of each virtual slot machine are stored after every play. The statistics are sent from the server to the player's client device 102. In another embodiment, the slot machines are physical slot machines in the game center. The statistics of each slot machine are sent from a statistics storage medium through the server to the player's client device 102. In one implementation of this embodiment, the slot machines for on-line play are located in an on-line play area not available to physical players of the game center. In another implementation, the slot machines of the game center can be shared by physical players and virtual players. A display panel on a physical slot machine or next to a physical slot machine displays statistics of the slot machine to the physical players.

Block 604 proceeds to block 606. At block 606, the server prompts the player to select a slot machine to play. In another embodiment, the server prompts the player to select a slot machine from slot machines that are available to be played. In yet another embodiment, a record is kept storing the identifier of a slot machine as the personal favorite slot machine of the player. For example, the slot machine last played by the player on a previous visit to the game center can be identified as the player's favorite machine. A slot machine that awarded the most recent winnings to the player on a previous visit can also be identified as the player's favorite machine. Block 606 proceeds to block 608. At block 608, the server determines if the selected slot machine is available to be played. The slot machine is not available if it is currently being played by another virtual or physical player, or if it is being taken off-line for maintenance. If the slot machine is not available, then block 608 returns to block 606 to prompt the player to select another slot machine. Otherwise block 608 proceeds to block 610.

Still referring to FIG. 6, at block 610, the server receives playing instructions on playing the next hand at the selected slot machine. Playing instructions may include instruction to “spin the wheel”, instruction to double the bet, instruction to triple the bet, and so forth. Block 610 proceeds to block 612. At block 612, a determination is made as to whether the use has finished playing. If the player has finished playing, for example if the player has entered a “finish” instruction at block 610, or if the player has not entered playing instructions within a specified time limit, then block 612 proceeds to an end block 618. Otherwise block 612 proceeds to block 614.

At block 614, the slot machine plays the received player instructions. In one embodiment, the received player instructions are automatically sent to the slot machine to be played. In another embodiment, a human operator plays the slot machine according to received player instructions. Although using human operators may be labor intensive, it may provide more of a realistic feeling to remote players. Using human operators can be limited to high roller slot machines to reduce the number of human operators required. Depending on the result of the play, either a winning is awarded to the player or no winning is awarded. Block 614 proceeds to block 616. At block 616, the statistics of the slot machine is updated to reflect the current progress. For example, winnings paid out by the slot machine and amounts entered into the slot machine are recorded with corresponding date and time. For a physical slot machine, its statistics is stored in a storage medium located within the slot machine or connected to the slot machine. The storage medium can be a volatile memory or a static memory. The statistics of multiple slot machines can be stored in the same storage medium as separate units of data. A display panel can be used to retrieve statistics from the storage medium and to display to physical players at the game center. In one embodiment in which multiple slot machines are connected by a slot machine server, the statistics for the each of the connected slot machines is stored in a database of the server. A virtual slot machine is simulated by a simulation computer. The virtual slot machine's statistics is stored in a database. The database is stored in a storage medium located within or connected to the simulation computer. Block 616 returns to block 610 to receive the player playing instructions on playing the next hand of the slot machine.

### Remote Player Playing Process

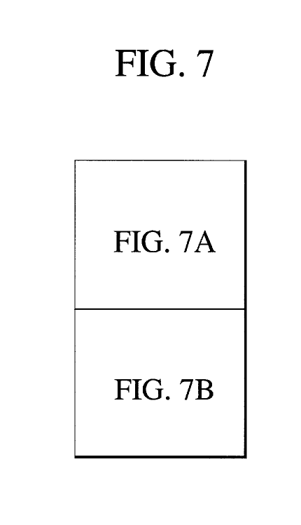

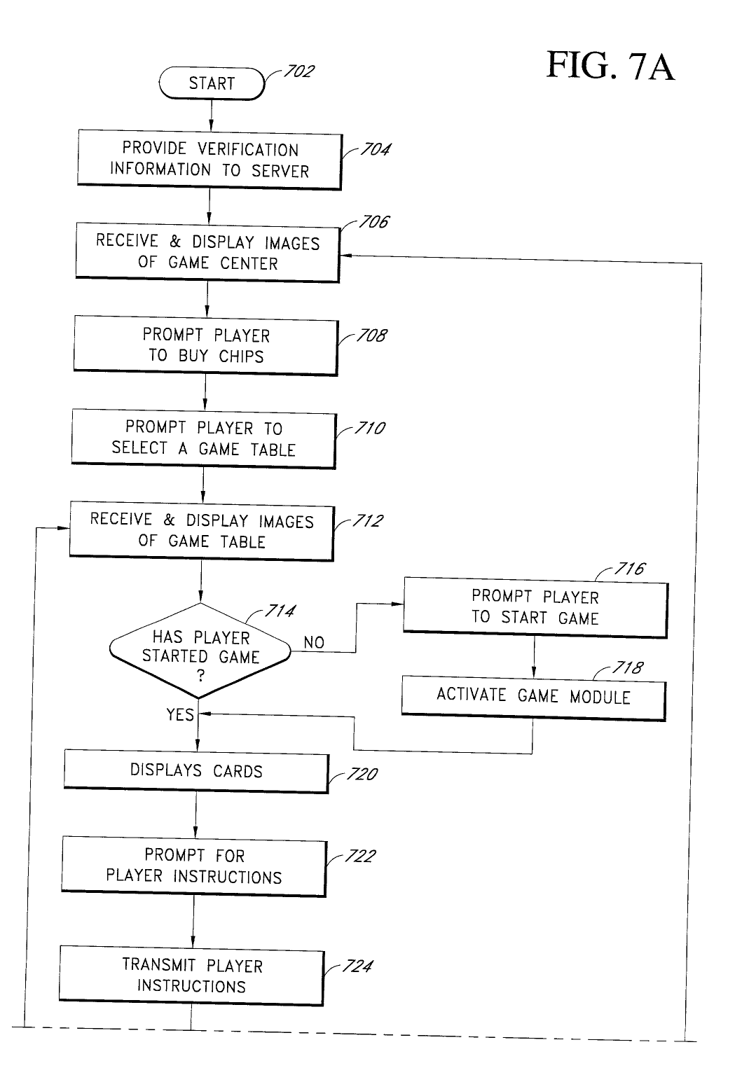

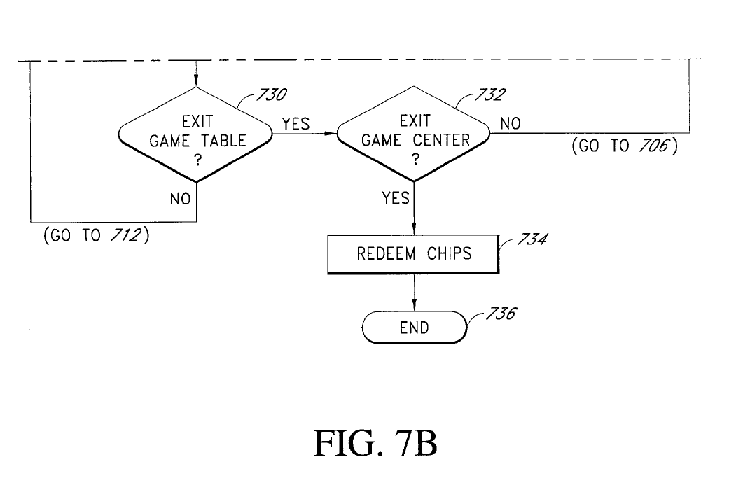

FIG. 7 is a flowchart showing one embodiment of a remote player playing process. FIG. 7 is separated into FIGS. 7A and 7B for ease of illustration. Referring to FIG. 7A, a start block 702 proceeds to block 704. At block 704, the client device 102 connects to a server serving a game center, and the remote player is prompted to provide verification information to the server. Details of one embodiment of a verification process have been described above in connection with FIG. 3. After the server verifies the player and grants the player's request to enter, block 704 proceeds to block 706. In one embodiment, based on the player's information such as country of origin, age, and/or gender, etc., a custom interface is presented to the player. For example, for a player that is identified as Chinese, a Chinese language interface can be presented to the player. For another example, based on the player's previously played games at the game center, or based on the most popular games played by other players from the same country and/or of the same age and gender, one or more games can be identified as the games mostly likely to be played by the remote player. These games can be displayed in prominent positions in the interface presented to the player. At block 706, the client device 102 receives from the server and displays video images of the game center. In one embodiment in which multiple game centers are connected to the server, the player is prompted to select a game center.

Block 706 proceeds to block 708, where the player is prompted to buy chips. After the player specifies the amount of chips to buy, the amount of chips remaining to the player is advantageously displayed on the client device 102 at all times, to remind the player of the amount of chips left. The amount of remaining chips is updated through the player playing process, depending on the player's winnings and loss.

In one embodiment, the player is prompted to buy chips when the player selects a game table to play. The purchase request is transmitted to the server, which transmits the request to the dealer at the selected game table. The server reduces the player's account balance by the purchase amount, and the dealer places the chips at the game table next to the player instructions system 408 that represents the player. When the player exits the game and the game table, the server increases the player's account balance by the amount of chips remaining at the game table, and the dealer removes the chips from the table. In another implementation, when the player exits the game and the game table, the server does not update the player's account balance, but keeps a record of the amount of remaining chips of the player. Therefore the player is able to virtually “carry the chips” to other game tables or other game centers that honor the same chips. When the player is ready to exit the game center or the server, the server “redeems” the player's remaining chips by increasing the player's account balance by the chip amount. The player is also provided with the option to keep the remaining chips at the player's game center account to be used next time at the game center. To encourage the player to keep the remaining chips with the game center, the game center can provide incentives to the player, such as awarding interests to the player on the remaining chips or adding free chips to the player's remaining chips.

In another embodiment, the player is prompted to enter a wagering amount for every wagering opportunity (such as every hand of cards) in a game. The wagering amount is transmitted to the server, which verifies the amount against the player's account balance. If the player has sufficient funds to make the wager, then the wager request is granted. Otherwise the wager request is denied and the player may be prompted to enter a lower wagering request. If the player's jurisdiction has specified a wagering amount limit or a casino credit limit for players, the server also verifies that the player's wager does not exceed his/her jurisdiction's limit.

Still referring to FIG. 7A, block 708 proceeds to block 710. At block 710, the player is prompted to select a game area in which a game is played, such as a game table in which a Black Jack game is played, a room in which Keno is played, a Wheel of Fortune wheel, or a slot machine. In one embodiment, the player is prompted to select a game table from the displayed images of the game center. In another embodiment, the player is prompted to select a game type such as Black Jack or slot machine, and is automatically assigned an available game table or slot machine that plays the selected game type. In a Wheel of Fortune game, a dealer spins the wheel and waits for the wheel to come to a final stop at a wheel landing area. The game of Black Jack is described below as an example. Block 710 proceeds to block 712. At block 712, the client device 102 receives and displays images of the selected game table. Details of providing images of a game table to remote players have been described above in the section titled “providing video images to the player.”

Block 712 proceeds to block 714. At block 714, a determination is made as to whether the player has started playing a game at the selected game table. If the player is already in the process of playing a game, block 714 proceeds to block 720. Otherwise block 714 proceeds to block 716. At block 716, the player is prompted to indicate that he/she is ready to participate in the next game. The player indication is transmitted to the dealer at the game table. The remote instructions system 408 is then activated at the game table to represent the player. Block 716 proceeds to block 718. At block 718, a game module is advantageously activated at the client device 102 or transmitted from the server to the client device 102. The game module includes instructions related to the game and allows the player to play the game according to the rules. The game module can be transmitted to the client device using a software-on-demand application described above. Block 718 proceeds to block 720.

At block 720, the cards dealt by the dealer are displayed at the client device 102. In one embodiment described above in the section titled “card scanning methods and devices,” a code embedded in each of the cards dealt by the dealer is scanned. The server then transmits the type of the card as text data or numerical data to the client device 102. A display application such as an applet is advantageously utilized to display a card at the client device 102 according to the received card type information. The display application may be downloaded from the server to the client device 102. Block 720 proceeds to block 722. At block 722, the player is prompted to enter instructions, such as “hit”, “stay”, “double”, “split”, and so forth. In one embodiment, the player speaks a voice command into a microphone connected to the client device 102. The client device 102 receives the voice command and uses a voice recognition program to recognize the instructions. The recognized instructions are then transmitted to the game table. In one implementation, the player trains the voice recognition program prior to starting the game. The player speaks a voice command, advantageously in his/her native language, and identifies to the voice recognition program the instruction that the voice command represents. After one or more iterations of training, the voice recognition program is able to recognize the player's voice commands. The player can also interact with the dealer, physical players and other remote players by entering and transmitting audio comments, by entering and transmitting video images of himself/herself, by entering and transmitting chat messages or instant messages, and so forth. Block 722 proceeds to block 724. At block 724, the player instructions are transmitted to the server, which transmits the player instructions to the remote instructions system 408 at the game table. Other data such as audio data, video image data, chat messages, instant messages, and so forth can also be transmitted. The dealer then executes the received player instructions. Block 724 proceeds to block 730.

Failure situations can occur during a game. For example, the communication link between a remote player and the server may be interrupted or disconnected by the remote player or by network error. A remote player may fail to enter playing instructions within a specified time limit during a game. Rules are set to determine that a failure has occurred. For example, a network monitoring program can be used to determine whether the network communication between the remote player and the server is functioning properly. A time limit such as ten seconds can be specified as the time limit under which the remote player must enter playing instructions. If a failure is determined to have occurred, contingency rules are used to continue the game at the game table 402. In one embodiment, a failed remote player is considered as having entered a “surrender” instruction for the current game. A “surrender” instruction orders the dealer to stop playing the player's hand, collect part of the player's wager for the game center, and return the other part of the player's wager to the player. The game center and the player usually each takes half of the player's wager. In another embodiment, a failed remote player is considered to be entering contingency instructions for the remainder of the game. Contingency instructions are computer-generated instructions to be played in the absence of player instructions. For example, contingency instructions such as “hit on 16 or less, stay on 17 or more” can be used as the failed remote player's instructions in a Black Jack game. In one implementation, the remote player can select, modify, or create contingency instructions for himself/herself prior to a game. For example, a conservative remote player may prefer contingency instructions such as “stay on 16 or more.” For another example, a player may select, modify, or create contingency instructions such as “split two 8's.” In the event of a failure, the server retrieves the remote player's contingency instructions to continue the current game.

Remote players can also back-bet on a game. A remote player selects a game table 402 and receives video images and/or audio signals of the game table 402. In one embodiment, car type information of each direct player and dealer at the game table 402 is transmitted to the remote player. In another embodiment, the remote player selects a direct player at the game table 402 and receives card type information of the selected direct player. A direct player is a remote or physical player that directly plays at the game table 402. An indirect player is a player that back-bets on a game at the game table 402. The indirect player transmits an instruction indicating he/she wishes to back-bet, a direct player selection, and a wager amount from the client device 102 to the server. If the indirect player back-bets on a game such as Black Jack or Roulette, then the indirect player does not enter further playing instructions. The direct player enters playing instructions or the dealer rolls the dices, and the indirect player's winning or loss is determined accordingly. If the indirect player back-bets on a game such as Caribbean Studs, the indirect player can choose to copy the direct player's playing instructions or enter instructions of his/her own. The indirect player's winning or loss is determined by the indirect player's playing instructions. Since the number of back-betting remote players at a game table 402 is not limited by physical space near the game table 402, and since a server instead of a dealer can receive back-betting instructions and determine results, a potentially unlimited number of remote players can back-bet at a limited number of game tables 402.

Referring to FIG. 7B, at block 730, a determination is made as to whether the player is exiting the game table. A player can indicate that he/she will not play the next game at the table by entering, for example, a “exit game table” instruction at the client device 102. In one embodiment, the player is determined to be exiting the game center if he/she has not placed a new wager within a specified time frame. If the determination is negative, i.e., if the player wishes to keep playing at the game table, then block 730 returns to block 712 to keep playing. Otherwise block 730 proceeds to block 732. At block 732, a determination is made as to whether the player is ready to exit the game center. A player can enter an instruction at the client device 102 to indicate he/she is ready to leave the game center. If the player is not ready to exit the game center, then block 732 returns to block 706. Otherwise block 732 proceeds to block 734. At block 734, the chips remaining with the player is redeemed. The server redeems the chips by increasing the player's account balance by the amount of the chips. In one embodiment in which the player did not purchase chips to play, the amount of winning or loss of the player is calculated, and the player's financial account is updated accordingly. When the player exits the game center, the server connects to a database of the game center or a database of a third party financial organization, and updates the player's financial account. In other embodiments, the player's financial account at the database can also be updated after the player exits a game table, after a game at the game table, or after each play. Block 734 proceeds to an end block 736. In another embodiment, the player may exit a game center but enter another game center hosted by the server to continue playing.

### Player Rewards Program

The playing information of remote players can be recorded by a server and stored into a user playing history database. The stored playing information can be used in a player rewards program. The playing information can include the name of the player, the identifier of the player, the amount of winning made by the player, the amount of money spent by the player, date and time of playing, the types of games played by the player, and so forth. Multiple casino chains or multiple casino locations within the same casino chain can share the same rewards program. In addition to being used for a player reward program, the information can also be used for other purposes, for example in making recommendations of product and services to the player, in determining the amount of casino credit to provide the player, and in determining whether to grant the player a VIP or preferred guest status. The information can also be used to comply with government reporting regulations and to ensure qualify of customer service.

In one embodiment, every time a remote player plays at a casino, the server checks the user against the user playing history database. If the amount of money spent by the player has reached a certain triggering amount, then the server announces a winning reward to the player. The server then prompts the player to designate an account to receive the winning, or transfers the winning amount to a default account of the player. In another embodiment, a fixed percentage of rebate is automatically credited to the player every time the player plays at the casino. Incentives can also be provided to the player in the form of extra play opportunities, such as prompting the player to “play a free hand!” at the expense of the game center, or informing the player that “the casino doubles this wager for you!” The playing information stored in the database can also be used to conduct drawings to award large prizes to one or more players. The drawings can be random, or partially correlated to the playing information, such as the amount of money a player has spent and the player's playing frequency. The player reward program can also replace or compliment the existing bonus program at a hotel or casino. For example, the money a player has spent on gaming can be used to earn bonus points toward free stays at the hotel. The money a player has spent at other services of the casino can earn cash points to be spent on gaming at the casino.

In another embodiment, physical players at the casino can also join in the player rewards program. For example, referring to FIG. 4, physical players can enter personal identification information on local consoles 410 at the game table 420. The rewards currently available to the physical player can be displayed on the local console 410. For example, as the player continues playing, the player can view on the local console 410 the increasing amount of bonus points or entitled prize winning. For remote players, the rewards information can be displayed on their client devices 102.

### Computerized Monitoring

A monitoring program can be used to replace or compliment human “pit bosses”. The monitoring program is designed to watch for irregularities, such as a physical player or remote player winning abnormally large amounts of money or winning constantly. In one embodiment, the monitoring program uses pattern recognition to analyze video images from cameras at the game table. For example, the monitoring program can be trained to distinguish normal dealer and physical player motions from abnormal dealer and physical player motions. If the video image of a dealer shows abnormal motions, such as the dealer reaching into his/her pocket, the monitoring program alerts a human security supervisor.

The monitoring program also acts as a coach or supervisor to the human dealer. Using information such as the types of cards dealt, the monitoring program can instruct the dealer on actions such as whether to hit or stand on the dealer's hand. When the monitoring program detects a card dealt to the dealer as an “Ace”, the monitoring program reminds the dealer to ask players if they wish to buy insurance. The monitoring program can issue warnings if the dealer makes an error, for example continuing to deal a card to the dealer after dealer's hand exceeds 17. A training device such as a device similar to the local console 410 can be placed next to the dealer 404 on the game table 402, to provide real time instructions to train an inexperienced dealer 404. The training device displays the playing instruction such as “hit” or “stand” regarding the dealer's hand, and displays the total count of every player's cards. The training device also displays the amount of money to be paid to or collected from each player after a game.

Since information such as the wining and losing amount on each player and dealer at every game table can be collected by the server, statistical data on winnings and losing can be used to provide tax, auditing and reporting data to the game center, to government regulatory bodies, and to players. The game center can use statistical data to analyze the popularity and profitability of various game types and game centers.

To prevent players, especially remote players from counting cards, cards can be shuffled frequently, such as every game, every other game, or every five games. A card shuffler can be used to shuffle cards, so that the dealer need not shuffle the cards. A large number of decks of cards, such as four, six, or eight decks of cards can be used. A continuous card shuffler can be integrated with the card shoe to shuffle cards after every game. After every game, the dealer retrieves the dealt cards and places them into the continuous card shuffler, which shuffles all cards in the shuffler. The dealer then deals cards from the shuffler. Since the cards are shuffled after every game, only a small number of decks of cards need to be used.

### Other Games

In addition to games in which players play against the game center, remote players can use the on-line system at a game center to play among themselves. The game center provides the on-line communication system and optionally the game table and the dealer. The game center charges the players a flat fee, a percentage of the total wager, or a percentage of the winnings. The game center obtains the financial account information from each player and ensures that each player has the sufficient fund that he/she wagers. The game center serves as an escrow service to ensure that the losing players cannot refuse to pay the winning players.

For example, remote players can join an on-line game center to play the game of poker. Referring to FIG. 4, the remote players select a game table 402 to play. A real dealer 404 at the game table 402 deals cards face down to the remote players, each represented by a remote instructions system 408. Each card is scanned, and the card information is transmitted to the remote player for whom the card is dealt. The remote players can interact through video, audio, chat room messages, instant messages, and so forth. The playing instructions, video images, audio signals, messages, and so forth are transmitted from the originating remote players through the server to the destination remote players.

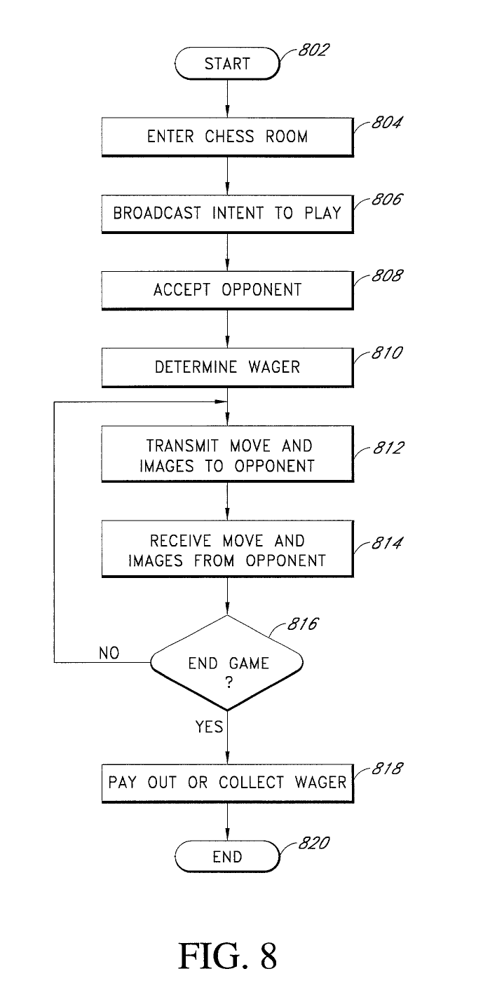

For another example, remote players can join an on-line game center to play a board game such as chess or monopoly. FIG. 8 is a flowchart showing one embodiment of a process of a remote player playing a game of chess against a remote or physical player. A start block 802 proceeds to block 804, where a remote player enters a chess room of the game center. The remote player is verified to ensure that he/she is permitted by law and financially capable of playing a wagered game. Details of one embodiment of a verification process have been described above in connection with FIG. 3. The chess room can be a computer simulated room or a real room with real chess boards. In one embodiment, a real chess board is located on a game table, such as the game table 402 illustrated in FIG. 4, to enable a physical player to play against a remote player. A human referee moves the chess pieces on the real chess board according to playing instructions from the remote player. In another embodiment, a chess board is displayed on a computer screen located on a game table, such as the game table 402 shown in FIG. 4. The physical player or remote player issues instructions to move the pieces on the chess board on the computer screen.

Still referring to FIG. 8, block 804 proceeds to block 806, where the remote player broadcasts his/her intent to find an opponent to play. The remote player's message can be broadcast to the entire chess room or the entire game center. The remote player may also limit the message receiver to his/her friends identified by player name or player identifier. Additional information, such as the remote player's rating, win/loss record at the chess room, video image, photo image, and so forth, can also be broadcast. Block 806 proceeds to block 808, where the remote player waits for an opponent's response, evaluates the opponent, and accepts or rejects the opponent. The remote player may evaluate the opponent by reviewing the opponent's information transmitted to the remote player, such as the opponent's name, rating, win/loss record, video image, photo image, and so forth. The opponent can be another remote player, or a physical player at the chess room. The remote player may also interact with the opponent using video images, audio conversation, chat messages, instant messages, and so forth. A physical player can interact with the remote player using an on-line device, for example the local console 410 illustrated in FIG. 4. If the remote player rejects the opponent, then the remote player continues waiting and evaluating other opponents until one opponent is accepted. Block 808 then proceeds to block 810.

At block 810, the remote player and his/her opponent determines a wager amount for each party. The parties may communicate using video images, audio conversation, chat messages, instant messages, and so forth. The parties may agree to enter unequal wager amounts. For example, party A, who is believed to be the stronger player, wagers (thus stands to lose) $100, while party B, who is believed to be the weaker player, wagers (thus stands to lose) $50. The server verifies that each party has sufficient funds to cover the wager. The parties also determine who starts first, for example by mutual agreement or by rolling a real or computer-generated dice. Block 810 proceeds to block 812, where the remote player starts the game and transmits his/her move to the opponent. Other information, such as his/her video images, photo images, chat messages, instant messages, audio comments, etc., can also be transmitted to the opponent. Block 812 proceeds to block 814, where the remote player receives the opponent's move and other information such as video images of the remote opponent, or video images of the game table where the physical opponent is located. In one embodiment in which the other player starts the first move of the game, the orders of block 812 and block 814 are reversed.

Still referring to FIG. 8, block 814 proceeds to block 816, where a determination is made as to whether the game has ended. The game ends when the parties agree to a draw, or when one party resigns. If the game has not ended, then block 816 returns to block 812 to continue playing. Otherwise block 816 proceeds to block 818, where the losing party pays out his/her wager to be collected by the winning party. The server transfers the wagered amount from the losing party's account to the winning party's account. The server also collects a flat fee or a percentage of the wager from the losing party or both parties. Block 818 proceeds to an end block 820.

For yet another example, remote players can join an on-line game center to play a computer game, such as a combat game, a role playing game, a strategy game, or a sports game. A plurality of player, for example dozens or hundreds of players, can play in the same game. In one embodiment, each player pays a wager amount to play the game, and the server transfers the losing players' wager amounts to the account(s) of the winning player(s). The server also transfers a flat fee or a percentage of the wager amounts to the game center.

Remote players can also join an on-line game center to place bets on a future outcome such as a sporting event. The betting events need not be limited to sporting events, but can be any events whose outcome can be reliably determined. In one embodiment, the remote players bet against each other, with the game center taking a percentage of the total wager or the winning. For example, remote players each enter a wager to predict the winner of the next World Cup Soccer tournament. The images of the events such as sporting events can be transmitted to the players, using the above-described devices. For example, the video images of a boxing match held at a casino can be transmitted to the players who have bet on the match. The television images of a sporting event can also be transmitted to players who bet on the event.

In another embodiment of betting on a future outcome, the game center sells or auctions the virtual ownership of a sports team, a race horse, a race car, or an athlete to one or more players at a price. The price is deducted from the financial accounts of the purchasing players and credited to the game center. The purchasing players become virtual owners. Different teams, horses, cars, and athletes can be purchased at different prices, depending on their expected chance of success. After a sporting event, the game center pays winning amounts to the virtual owners of the winning teams, horses, cars, and athletes. This embodiment provides to the players a sense of ownership and therefore great incentive.

In addition to real sporting events, a sporting event can be simulated and displayed. For example, based on the team and individual player statistics of NBA teams, such as team win-loss percentage, team average scoring per game, player average rebounds per game, player shooting percentage, and so forth, a computer simulates the plays of a 48-minute basketball game between two NBA players. The simulated game can be displayed as a pre-game show prior to the start of the real game. Physical and remote users can enter wagers to predict the result of the simulated game.

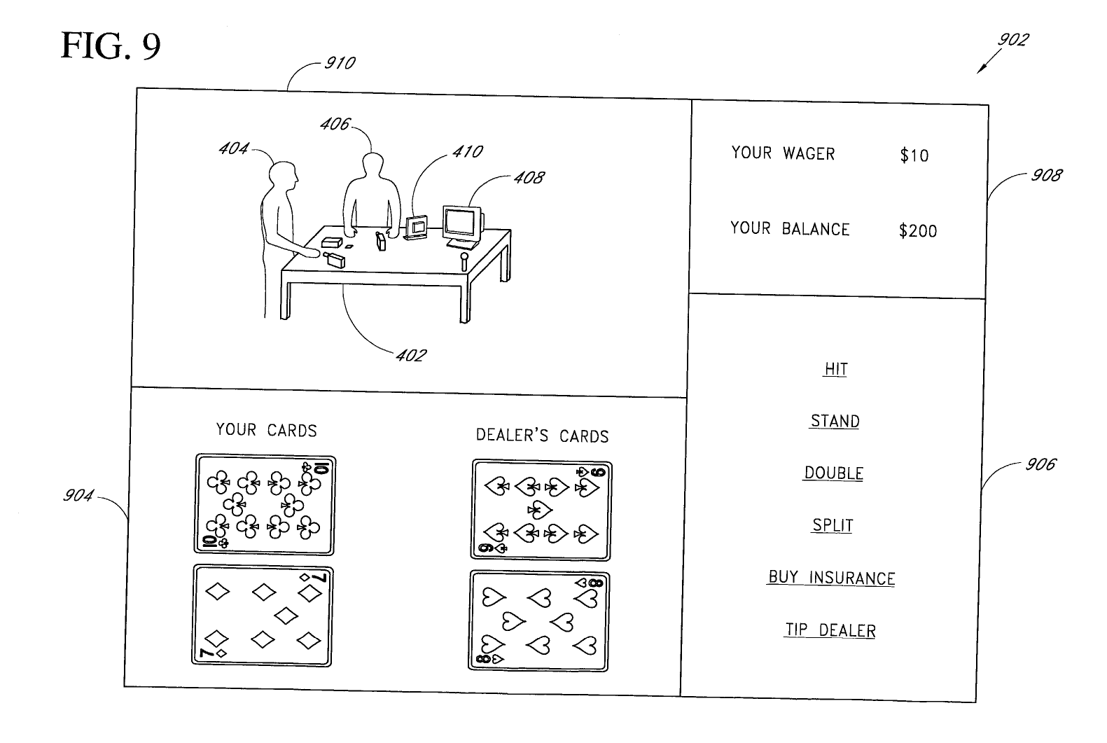

FIG. 9 is a diagram showing one embodiment of a client device display. A display screen for Black Jack is shown as an example. The display screen 902 on the client device 102 includes a card section 904, an instruction section 906, a wager section 908, and an image section 910. The card section 904 displays graphic representations of the types of cards being dealt to the remote player and the dealer. The instruction section 906 displays the playing instructions available to the player. The remote player enters playing instructions by selecting instructions in section 906 or speaking an audio command. The wager section 908 displays the amount of the player's current wager and the player's remaining balance for game play. The player can specify a wager amount by entering an amount in section 908. Section 910 displays a video image of the game table 902 transmitted from the game center.

This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A game table for a remote player to participate in a card game, the game table comprising:
a card scanner configured to scan a card and to determine a type of the card, the card having an embedded code that indicates the type of the card, the card scanner being connected to a server, the server being configured to transmit the type of the scanned card to the remote player;
one or more cameras connected to the server, the cameras being configured to capture video images of the game table, the server being further configured to transmit the captured video images to the remote player; and
a remote instruction system configured to receive playing instructions from the remote player through the server, and to display the received playing instructions at the game table in visual or audio form.

2. The game table of claim 1, wherein the card scanner is configured to scan a card using a radio signal.

3. The game table of claim 1, wherein the card scanner is configured to scan a card using an infrared signal.

4. The game table of claim 1, wherein the card scanner is configured to scan a card using a barcode reader.

5. The game table of claim 1, wherein the cameras comprise an overhead camera configured to capture video images of an overhead view of the game table.

6. The game table of claim 1, wherein the cameras comprise a dealer camera configured to capture video images of a dealer of the game table.

7. The game table of claim 1, wherein the cameras comprise a physical player camera configured to capture video images of a physical player of the game table.

8. The game table of claim 1, further comprising a local console configured to allow a physical player at the game table to enter playing instructions.

9. The game table of claim 1, further comprises a microphone connected to the server, the microphone being configured to record audio signals at the game table, the server being further configured to transmit the recorded audio signals to the remote player.

10. A physical slot machine configured to display playing statistics, the slot machine comprising:
a storing medium located within the slot machine or connected to the slot machine, the storing medium being configured to store a result for each of a plurality of plays at the slot machine; and
a display device located at the slot machine or connected to the slot machine, the display device being configured to display at least a summary of the stored results.

11. The slot machine of claim 10, wherein the physical slot machine is connected to another physical slot machine.

12. A method of enabling a remote player to select a slot machine to play, the method comprising:
storing statistics of a first slot machine and statistics of a second slot machine;
displaying to the player at least a summary of the stored statistics of the first slot machine;
displaying to the player at least a summary of the stored statistics of the second slot machine; and
prompting the player to select a slot machine from a plurality of slot machines, the plurality of slot machines including the first slot machine and the second slot machine.

13. The method of claim 12, wherein each of the plurality of slot machines is a physical slot machine located at a physical game center.

14. The method of claim 12, wherein each of the plurality of slot machines is a virtual slot machine simulated by a computer program.

15. A method of creating security requirements at a web site, the method comprising:
displaying a plurality of available verification fields to an administrator of the web site;
prompting the administrator to select one or more verification fields from the plurality of available verification fields; and
prompting a user to enter data into the selected verification fields when the user requests entry into the web site.

16. The method of claim 15, further comprising verifying user entered data to determine whether to allow the user to enter into the web site.

17. The method of claim 16, wherein verifying user entered data comprises comparing user entered data against user information stored in a user information database connectable to the web site.

18. The method of claim 16, further comprising prompting the user to insert a smart card into a smart card drive when the user requests entry into the web site.

19. The method of claim 16, further comprising prompting the user to insert a smart disk into a disk drive when the user requests entry into the web site.

20. The method of claim 18, wherein verifying user entered data comprises comparing user entered data against data stored on the smart card.

21. The method of claim 19, wherein verifying user entered data comprises comparing user entered data against data stored on the smart disk.

22. A method of creating security requirements at a web site having a plurality of sub-sites, the method comprising:
displaying a plurality of available verification fields to an administrator of the web site;
for each of the plurality of sub-sites of the web site, prompting the administrator to select one or more verification fields from the plurality of available verification fields; and
prompting a user to enter data into the selected verification fields when the user requests entry into a sub-site of the web site.

23. A method of enabling a remote player to participate in a game at a physical game center, the method comprising:
prompting the remote player to connect to a server that hosts the physical game center;
verifying that the remote player is permitted by his/her jurisdiction to play at the game center;
verifying that the remote player is financially qualified to play at the game center;
identifying a financial account of the remote player;
prompting the remote player to enter playing instructions;
receiving the entered playing instructions at the game center;
playing a game at the game center according to the received playing instructions;
transmitting a status of the played game to the remote player;
optionally transmitting video images of the played game to the remote player; and
updating a balance of the identified financial account of the remote player.

24. The method of claim 23, wherein verifying that the remote player is permitted by his/her jurisdiction to play comprises comparing the remote player's age against his/her jurisdiction's age limit.

25. The method of claim 23, wherein verifying that the remote player is financially qualified to play comprises examining the remote player's financial information stored in a smart card of the remote player.

26. The method of claim 23, wherein verifying that the remote player is financially qualified to play comprises examining the remote player's financial information stored in a smart disk of the remote player.

27. The method of claim 23, wherein verifying that the remote player is financially qualified to play comprises examining the remote player's financial information stored in a financial database of the game center.

28. The method of claim 23, wherein verifying that the remote player is financially qualified to play comprises examining the remote player's financial information stored in a financial database of a third party financial organization.

29. The method of claim 23, wherein identifying a financial account of the remote player comprises identifying a smart card account of the remote player.

30. The method of claim 23, wherein identifying a financial account of the remote player comprises identifying an e-wallet account of the remote player.

31. The method of claim 23, wherein identifying a financial account of the remote player comprises identifying a bank account of the remote player.

32. The method of claim 23, wherein identifying a financial account of the remote player comprises identifying a credit card account of the remote player.

33. The method of claim 23, further comprising prompting the remote player to select a game to play.

34. The method of claim 23, further comprising prompting the remote player to select a game area to play.

35. The method of claim 34, wherein prompting the remote player to select a game area comprises prompting the remote player to select a game table.

36. The method of claim 34, wherein prompting the remote player to select a game area comprises prompting the remote player to select a slot machine.

37. The method of claim 23, wherein prompting the remote player to enter playing instructions comprises prompting the remote player to speak audio commands.

38. The method of claim 23, wherein receiving the entered playing instructions comprises:
receiving the entered playing instructions in a first format at the server;
converting the playing instructions in a first format into playing instructions in a second format; and
transmitting the playing instructions in the second format from the server to the game center.

39. The method of claim 38, wherein the first format is a non-audio format and the second format is an audio format.

40. The method of claim 38, wherein the first format is an audio format in a first language and the second format is an audio format in a second language.

41. The method of claim 23, wherein transmitting a status of the played game comprises transmitting a type of a card of the played game.

42. The method of claim 23, wherein transmitting a status of the played game comprises transmitting a number of a rolled dice of the played game.

43. The method of claim 23, wherein transmitting a status of the played game comprises transmitting a type of a wheel landing area of the played game.

44. The method of claim 23, wherein optionally transmitting video images of the played game comprises optionally streaming the video images to the remote player.

45. The method of claim 23, wherein playing the game comprises using a human operator to carry out the received playing instructions from the remote player.

46. The method of claim 23, further comprising connecting the game center to another game center.

47. The method of claim 23, wherein updating a balance of the identified financial account comprises updating the balance when the remote player is ready to exit the game center.

48. The method of claim 23, wherein updating a balance of the identified financial account comprises updating the balance when the remote player is ready to exit a game area.

49. The method of claim 23, wherein updating a balance of the identified financial account comprises updating the balance when the result of a bet entered by the remote player has been determined.

50. A method of a player playing a game at a remote physical game center, the method comprising:
connecting to a server that hosts the game center;
entering verification information to satisfy legal requirements;
entering playing instructions to a game to be played or being played at the game center;
receiving a status of the played game from the server; and
optionally receiving video images of the played game from the server.

51. The method of claim 50, wherein the game is a slot machine game, the method further comprising receiving statistics of the slot machine.

52. The method of claim 50, wherein receiving a status of the played game comprises receiving a type of a card of the played game.

53. The method of claim 52, wherein receiving a type of a card comprises receiving a type of a card scanned by a card scanner connected to the server.

54. The method of claim 50, wherein receiving a status of the played game comprises receiving a number of a rolled dice of the played game.

55. The method of claim 50, wherein receiving a status of the played game comprises receiving a type of a wheel landing area of the played game.

56. The method of claim 50, further comprising receiving player rewards information from the server.

57. A method for enabling a remote player to participate in a game played in a casino remotely located from said remote player and providing the remote player with a realistic game experience that substantially captures the visual feel and excitement of the casino, the method comprising:
transmitting images to said remote player of a game in progress;
identifying a financial account of said remote player;
prompting said remote player when it is said remote player's turn to play to enter playing instructions during the game;
receiving at said casino the entered playing instructions from said remote player while the game is being played;
receiving from said remote player an amount of wager specified by said remote player; and
communicating to said remote player the ongoing status of the game in substantially real time.

58. The method of claim 57, further comprising transmitting to said remote player sounds of the game and voices of a dealer and on-site players.

59. A method for enabling a remote player to participate in a game played in a casino remotely located from said remote player and providing the remote player with a realistic game experience that substantially captures the visual and audio feel and excitement of the casino, the method comprising:
transmitting images to said remote player of a game in progress;
transmitting to said remote player sounds of the game and voices of a dealer and on-site players;
identifying a financial account of said remote player;
prompting said remote player when it is said remote player's turn to play to enter playing instructions during the game;
receiving at said casino the entered playing instructions from said remote player while the game is being played;
receiving from said remote player an amount of wager specified by said remote player;
communicating to said remote player the ongoing status of the game in substantially real time; and
communicating to said remote player an amount of balance retained by said remote player.
